(19) United States
(12) Patent Application Publication
(10) Pub. No.: US 2019/0263501 A1
(43) Pub. Date: Aug. 29, 2019

(54) A Manually Detachable Locking Mechanism

(71) Applicant: XDynamics Limited, Hong Kong (HK)

(72) Inventors: Xinghua Wang, HuJia Ying Town (CN); Mah Wah Chan, Mid-Levels (HK)

(73) Assignee: XDynamics Limited, Hong Kong (HK)

(21) Appl. No.: 16/330,926

(22) PCT Filed: Nov. 17, 2016
(86) PCT No.: PCT/CN2016/106229

§ 371 Date: Mar. 6, 2019

(51) Int. Cl. B64C 11/04; B64C 27/48

(52) U.S. Cl. CPC B64C 11/04; B64C 27/08; B64C 27/48

(57) ABSTRACT

A manually detachable locking mechanism for connecting parts of an unmanned aerial vehicle (UAV) having a first engaging means associated with a first part of the UAV; a second engaging means associated with a second part of the UAV, the first engaging means and the second engaging means being manually and releasably engageable to connect the first and second parts; a resilient means operatively arranged between the first engaging means and the second engaging means. The first engaging means is movable relative to the second engaging means along a direction of an axis from a first position to a second position and then from the second position to a third position angularly spaced from the second position about the axis to thereby lock the first engaging means with the second engaging means under a restoring force exerted by the resilient means. An unmanned vehicle having a manually detachable locking mechanism is described.

This is a US national phase entry patent application claiming priority to PCT application No. PCT/CN2016/106229 filed 17 Nov. 2016, which is incorporated herein for all purposes.

### FIELD OF THE INVENTION

The invention relates to a manually detachable locking mechanism for connecting parts of an unmanned vehicle, and particularly, but not exclusively, to a manually detachable locking mechanism for connecting propellers or parts of a propeller of an unmanned aerial vehicle such as a multi-copter.

### BACKGROUND OF THE INVENTION

There has been a rapid development in the field of unmanned vehicles and particularly, in the technology of unmanned aerial vehicles (UAV) such as multi-copters and drones. A conventional UAV may comprise one or more propellers outwardly extended from its main body at certain angles to facilitate the flight. Specifically, each propeller may typically comprise two or more propeller blades connected with a respective rotor for generating the lift and the thrust required for flying the UAV. Features and configurations of the propellers are thus critical in the design of a UAV and play an important role in flight stability and control.

One known problem associated with conventional UAVs is that they are often bulky and relatively heavy, and thus are not so convenient to be carried around by the user and to store. Particularly, the extended arrangement of the propellers from the main body of the UAV renders the propeller parts, such as the delicate blade portions, as being susceptible to unintentional external impacts or being easily damaged when the UAV is transported from place to place, which may result in dislocations or fractures to the propeller parts. It is not uncommon that frequent replacement of the propeller parts of a conventional UAV is usually required, which is undesirable in terms of costs and user's experience.

### OBJECTS OF THE INVENTION

An object of the present invention is to provide a mechanism for connecting and disconnecting parts of an unmanned aerial vehicle such as a drone or a multi-copter.

Another object of the present invention is to mitigate or obviate to some degree one or more problems associated with known unmanned aerial vehicles, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a manually detachable locking mechanism for connecting parts of an unmanned aerial vehicle (UAV). The locking mechanism comprises a first engaging means associated with a first part of the UAV; a second engaging means associated with a second part of the UAV, said first engaging means and said second engaging means being manually releasably engageable to connect said first and second parts; a resilient means operatively arranged between the first engaging means and the second engaging means; wherein the first engaging means is movable relative to the second engaging means along a direction of an axis from a first position to a second position and then from the second position to a third position angularly spaced from the second position about the axis to thereby lock the first engaging means with the second engaging means under a restoring force exerted by the resilient means.

In a second main aspect, the invention provides an unmanned aerial vehicle (UAV) comprising a propeller blade unit having a plurality of blades connected at a propeller shaft; a rotor unit; and the manually detachable locking mechanism according to the first main aspect. In a third main aspect, the invention provides a propeller blade unit for an unmanned aerial vehicle (UAV). The propeller blade unit comprises a plurality of blades connected at a shaft; the shaft comprising at its lower portion an engaging means adapted to manually releasably engage a rotor of a rotor unit to thereby allow the plurality of blades be rotatable about an axis of the shaft; wherein the engaging means comprises at least one protruding portion resiliently engageable with at least one corresponding receiving portion at the rotor to thereby lock the propeller blade unit at the rotor unit via a guided press and twist movement.

In a fourth main aspect, the invention provides a rotor unit for an unmanned aerial vehicle (UAV). The rotor unit comprises an engaging means adapted to receive a shaft of a propeller blade unit; the engaging means comprising a resilient means arranged to allow a resilient engagement of the engaging means with the shaft; a guide portion adapted to guide movement of the received shaft relative to the engaging means; a recess adapted to lock position of the received shaft at the engaging means; wherein the guide portion comprises a tapered portion slidably engageable by a protruding portion arranged at the shaft, such that the protruding portion is guided to move along a surface of the tapered portion and be subsequently received by the recess to thereby lock the propeller blade unit at the rotor unit. The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a perspective view showing a manually detachable locking mechanism in accordance with an embodiment of the present invention for connecting a propeller blade unit with a propeller rotor unit of an unmanned aerial vehicle (UAV);

FIG. 2 is an exploded, perspective view of an engaging means of the propeller rotor unit of FIG. 1;

FIG. 3 is a perspective view showing the engaging means of the propeller rotor unit of FIG. 1;

FIG. 4 shows one exemplified locking action according to an embodiment of the present invention; and

FIG. 5 is shows another exemplified locking action according to an embodiment of the present invention.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention relates to a manually detachable locking mechanism for connecting parts of an unmanned vehicle such as, but not limited to, parts of one or more propellers of an unmanned aerial vehicle (UAV) which can be a multi-copter or a drone. A multi-copter is generally considered to be a remotely controlled unmanned aerial vehicle normally having four or more propellers, but having at least one pair of counter-rotating propellers thus negating the need for a tail rotor as required in most helicopters. In the context of the present description, the expression “manually detachable” is generally used to describe the locking mechanism as being manipulable to attach and detach, connect and disconnect or the like of two corresponding parts of the vehicle by only the user's hand or hands without requiring the use of a tool such as, for example, a screwdriver, a plier or a wrench. The manually detachable locking mechanism is beneficial in providing a quick and easy connection as well as release of such connection for assembling a propeller blades unit with a propeller rotor unit of a UAV such as a drone. The simple connecting and releasing steps allow a more compact structure and also weight reduction at a drone design to thereby enhance applicability of the drone and user's experience.

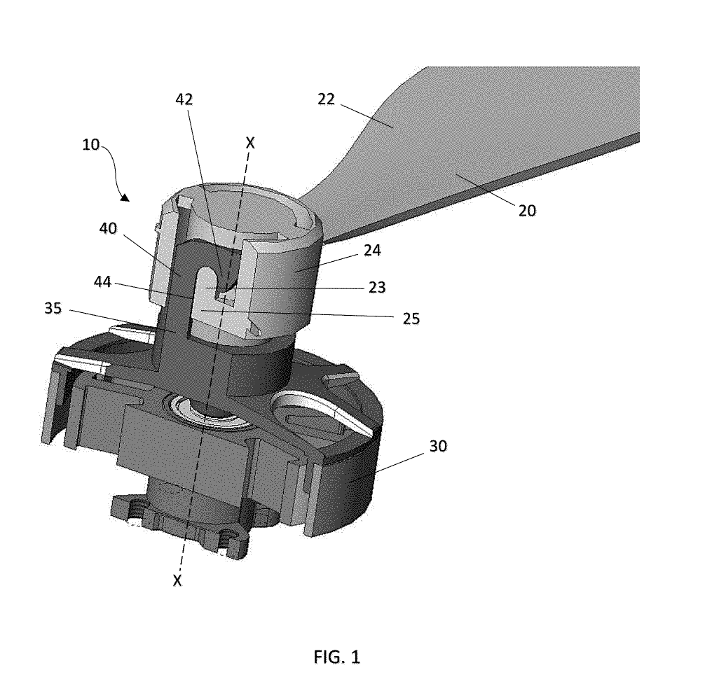

Referring to FIG. 1, shown is an embodiment of a manually detachable locking mechanism 10 for use in connecting a propeller blade unit 20 with a propeller rotor unit 30 of a motor of a UAV such as a drone. The propeller blade unit 20 may generally comprise a plurality of blades 22 connected at a propeller shaft or hub 24. The propeller rotor unit 30 can be any known electrically powered rotor rotatable at high speed to allow rotation of the connected propeller blades 22 and thus generating the required forces to fly drone. FIG. 1 shows the configuration of the blade unit 20 being locked with the rotor unit 30 to form an operative propeller of a UAV.

Particularly, the locking mechanism 10 comprises a first engaging means 25 associated with the propeller blade unit 20, and preferably, arranged at a lower portion of the shaft 24 of the propeller blade unit 20; and a second engaging means 35 associated with the propeller rotor unit 30, and preferably, arranged at an upper portion of the rotor unit 30. The first engaging means 25 and the second engaging means 35 are manually and releasably engageable to connect the propeller blade unit 20 with the propeller rotor unit 30 along an axis X-X of the shaft 24 to thereby allow rotation of the connected plurality of blades 22.

In the embodiment as shown in FIG. 1, the second engaging means 35 may be provided with at least one hook-like structure 40 extending away from the rotor unit 30 along the axis X-X. Preferably, the hook structure 40 can be configured to define a tapered portion 42 and a recess 44. More preferably, the tapered portion 42 and the recess 44 can be integrally formed as parts of the hook structure 40. In one embodiment, the second engaging means 35 may comprise a plurality of hook structures 40 arranged to define a space for receiving at least part of the first engaging means 25 such as the shaft 24.

The recess 44 can be arranged to engage or receive a corresponding protruding portion 23 provided at the first engaging means 25, with the protruding portion 23 being configured to generally conform with the recess 44 to thereby allow a secure positioning or locking of the first engaging means 25 with the second engaging means 35. For example, the protruding portion 23 may comprise an elongated member such that it can be snugly received by a groove or a slot of the recess 44, as shown in the embodiment of FIG. 1. Alternatively, the protruding portion 23 may comprise a round or oval shaped dot or a bulge for engaging a suitably shaped recess 44. It is understandable that the shapes and configurations of the protruding portion 23 and the recess 44 should not be limited to the above described embodiments, but any possible variations shall be encompassed by the present invention as long as they are capable of being securely engaged and thus operatively locked the blade unit 20 with the rotor unit 30.

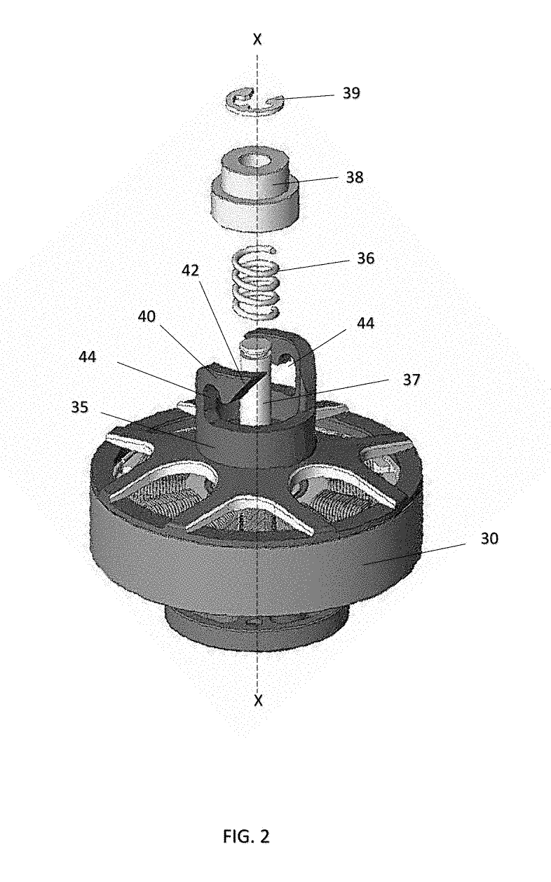

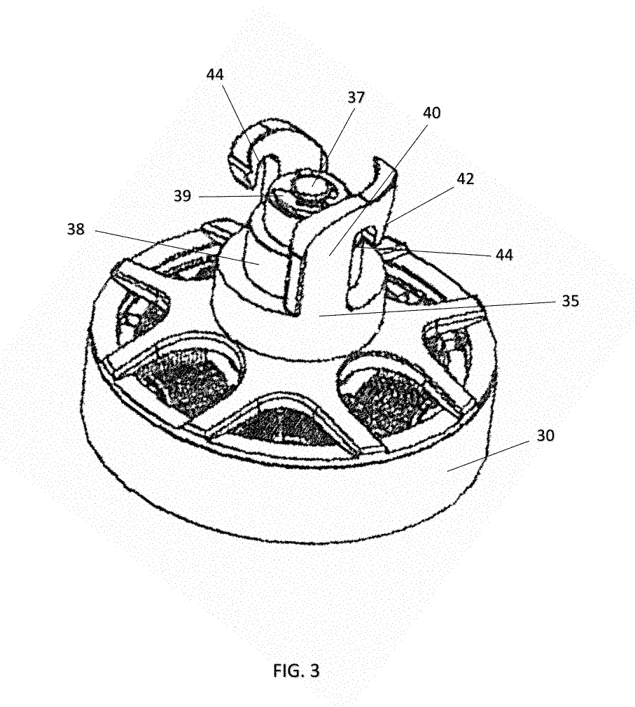

As shown in the exploded view of FIG. 2, the rotor unit 30 may further comprise a resilient means 36 operatively arranged between the first engaging means 25 and the second engaging means 35 for resilient movement therebetween. In this embodiment, the resilient means 36 is provided in the form of a coil spring 36 having a spring constant ranged from about 1 N/mm to about 3 N/mm and is arranged to sleeve-fit over a central core 37, with the coil spring 36 being subsequently covered by a spring cap 38. The coil spring 36 and the spring cap 38 can be retained at the core 37 by, for example, a resilient clamp, circlip 39 or the like to form a resilient unit. FIG. 3 further shows an assembled view of the rotor unit 30 showing the arrangement of the second engaging means 35 having two hook structures 40 which at least partially surround the resilient unit at the center.

To connect the propeller blade unit 20 with the propeller rotor unit 30, the user may first arrange the first engaging means 25 to move relative to the second engaging means 35 along the direction of the axis X-X from a first position P1 to a second position P2, which is preferred to be a linear movement towards the second engaging means 35 along the direction X-X. This can be achieved by an action of the user such as the compressing of the first engaging means 25 towards the second engaging means 35, although an opposite movement in moving the first engaging means 25 away from the second engaging means 35, such as by a drawing action of the user, is also possible. The first engaging means 25 is then rotatably movable from the second position P2 to a third position P3 angularly spaced from the second position P2 about the axis X-X, such as by means of a rotating, twisting or turning action of the user, to thereby lock the first engaging means 25 with the second engaging means 35. For example, a slot 44 which is horizontally arranged along a plane defined by P2 and P3 may receive a protruding portion 23 to securely lock the second engaging means 35 with the first engaging means 25.

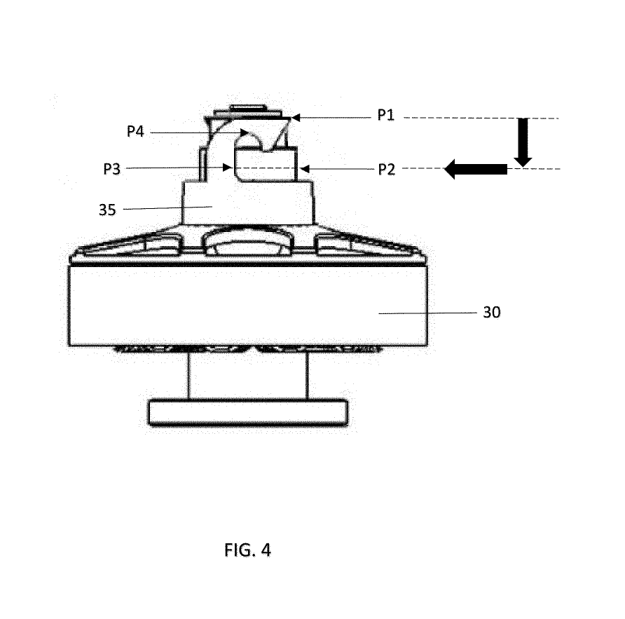

In one embodiment, linear movement of the first engaging means 25 relative to the second engaging means 35 along the direction X-X from the first position P1 to the second position P2 may result in loading of the resilient means 36 into a loaded state, for example, as a result of a compression action of the first engaging means 25 by the user. While maintaining the loaded state of the resilient means 36 by maintaining the compression, the first engaging means 25 can be arranged to move from the second position P2 to the third position P3 angularly spaced from the second position, such as by a rotating, twisting or turning action of the user, to thereby lock the first engaging means 25 with the second engaging means 35 under a restoring force exerted by the resilient means 36. In this embodiment, locking of the first and the second engaging means 25, 35 is achievable by a combined, two-steps action, i.e. a vertical or linear movement from P1 to P2 during a pressing action of the user, followed by a substantially horizontal movement from P2 to P3 during a twisting, rotating or turning action of the user, as shown in FIG. 4.

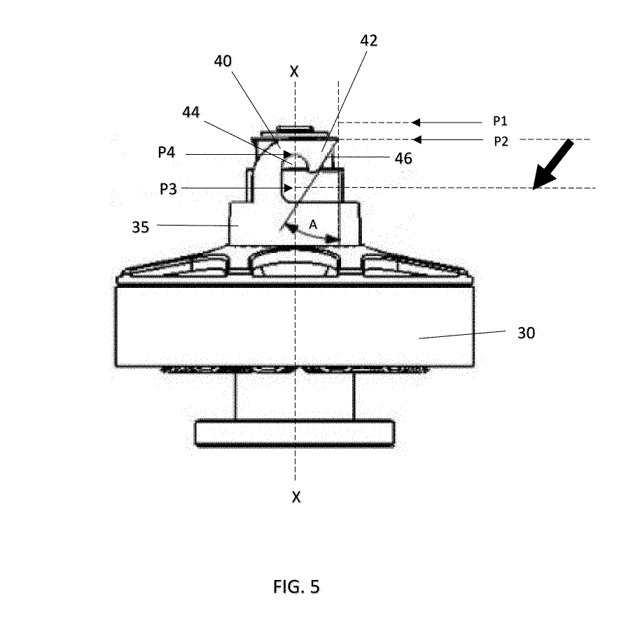

In another embodiment, the first engaging means 25 can be linearly movable relative to the second engaging means 35 along the direction X-X from the first position P1 to the second position P2 without biasing the resilient means 36. The first engaging means 25 is then movable by, for example, a twisting action of the user along a guide portion 46 of the second engaging means 35 from the second position P2 to the third position P3 angularly spaced from the second position P2 about the axis X-X to thereby load the resilient means 36 into a loaded state and lock the first engaging means 25 with the second engaging means 35. The loading of the resilient means 36 and the locking of the first and the second engaging means 25, 35 can thus be achieved simultaneously in a single step, i.e. the angular movement from P2 to P3 along the guide portion 46 during a twisting action of the user, as shown in FIG. 5. Alternatively, a pressing step can be included to bias to the resilient means 36 prior to the guided twisting step to thereby connect the two engaging means 25, 35 via a two-steps, guided press and twist action.

Preferably, the guide portion 46 comprises the tapered portion 42 having an inclined surface, with the inclined surface being slidably engageable by the first engaging means 25, or more specifically, the protruding portion 23 of the first engaging means 25 to thereby guide the first engaging means in moving from the second position P2 to the third position P3. In one specific embodiment, the inclined surface defines an angle of inclination A with a vertical plane parallel to the axis X-X in the range of about 30 degree to about 50 degree, and more preferably, 33.5 degree. The larger the inclined angle A, the greater the amount of turning or twisting will be required by the user to move the first engaging means 25 from P2 to P3.

In one further embodiment, after the first engaging means 25 is arranged at the third position P3 relative to the second engaging means 35 during the locking action, the first engaging means 25 is preferred to move further from the third position P3 to a fourth position P4 along the direction of the axis X-X relative to the second engaging means 35, and more preferably, to move away from the second engaging means 35 from P3 to P4, to thereby restore the resilient means 36 to a partially relaxed state. Specifically, the fourth position P4 is angularly spaced from the first position P1, with the angular spatial arrangement being similar to that between the second position P2 and the third position P3. The partially relaxed state of the resilient means 36 at P4 allows a sufficiently secure engagement between the first and the second engaging means 25, 35 due to the remaining biasing force from the resilient means 36, such that the blades unit 20 and the rotor unit 30 will not be moving or shaking about the connection when the vehicle is in motion such as during a flight. In one embodiment, the third position P3 and the fourth position P4 can be defined by the recess 44 of the second engaging means 35, such that when the first engaging means 25 is arranged to engage the second engaging means 35, the protruding portion 23 of the first engaging means 25 is movable between P3 and P4 within the recess 44. The partially restoring resilient movement from P3 to P4 also assists in generating a sense or sound of impact such as a “click” sound, depending on the materials of the two engaging means, when the protruding portion 23 is released and is allowed to strike at a wall of the recess 44 under the resilient force of the resilient means 36. This sense or sound of impact is a useful indicator readily perceivable by the user during the connection that a secure connection has successfully been made.

In one specific embodiment, at least one of the first engaging means 25 and the second engaging means 35 is formed of a sufficiently high strength material preferably comprising one or more metals or metal alloys, such as but not limited to, stainless steel or aluminium, with hardness ranged from about HB60 to about HB100 at the Brinell scale under the standard testing condition, and more preferably, from about HB90 to about HB95. These specific physical properties of the first and the second engaging means 25, 35 are preferred to thereby ensure the durability of the connecting parts and thus the security of the connection, as well as the ability of the engaging means 25, 35 to withstand the biasing force from the resilient means 36. Furthermore, the combination of various features including the preferred hardness of the first and second engaging means 25, 35; the specific angle of inclination A of the tapered portion 42 of the second engaging means 35; the shape, configuration and position of the recess 44 of the second engaging means 35 as well as the shape, configuration and position of the protruding portion 23 of the first engaging means 25; and also the resilience, i.e. the force verse the compression of the resilient means 36 etc. can be customised or tailored in the configuration of the locking mechanism 10 to provide the user with the preferred sense or sound of connection to thereby indicate that a secure connection between the blades unit 20 and the rotor unit 30 is achieved.

The present invention also relates to an unmanned aerial vehicle (UAV) which comprises the manually detachable locking mechanism 10 as described above. Specifically, the UAV comprises a propeller blade unit 20 having a plurality of blades 22 connected at a propeller shaft 24, and a rotor unit 30 connectable with the shaft 24 via the manually detachable locking mechanism 10 as above described. The present invention further relates to the propeller blades unit 20 and the propeller rotor unit 30 as described above.

The present invention is advantageous in that it provides a manually detachable locking mechanism for connecting parts, such as but not limited to, one or more propellers of an unmanned aerial vehicle (UAV) which can be a multi-copter or a drone. Particularly, the locking mechanism is applicable to easily attach and detach two corresponding propeller parts of the UAV or the drone by only the user's hand or hands without requiring the use of a tool such as a screwdriver, a plier or a wrench. The manually detachable locking mechanism is beneficial in providing a quick and easy connection as well as release of such connection for assembling parts such as a propeller blades unit with a propeller rotor unit of a UAV or a drone. The manual yet simple connecting and releasing steps allow more compact structure and weight reduction at a drone design which significantly enhances experience of the user. Furthermore, upon connection of the locking mechanism, it is capable of providing a sense or sound perceivable by the user to thereby indicate that a secure connection between the connecting parts has been established.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A manually detachable locking mechanism for connecting parts of an unmanned aerial vehicle (UAV), comprising:
a first engaging means associated with a first part of the UAV;
a second engaging means associated with a second part of the UAV, said first engaging means and said second engaging means being manually and releasably engageable to connect said first and second parts;
a resilient means operatively arranged between the first engaging means and the second engaging means;
wherein the first engaging means is movable relative to the second engaging means along a direction of an axis from a first position to a second position and then from the second position to a third position angularly spaced from the second position about the axis to thereby lock the first engaging means with the second engaging means under a restoring force exerted by the resilient means.

2. The manually detachable locking mechanism according to claim 1, wherein the first engaging means is movable relative to the second engaging means along the direction of the axis from the first position to the second position to thereby load the resilient means into a loaded state, and while maintaining the loaded state of the resilient means, the first engaging means is movable from the second position to the third position angularly spaced from the second position to thereby lock the first engaging means with the second engaging means.

3. The manually detachable locking mechanism according to claim 1, wherein the first engaging means is movable relative to the second engaging means along the direction of the axis from the first position to the second position, the first engaging means is then movable along a guide portion of the second engaging means from the second position to the third position angularly spaced from the second position about the axis to thereby load the resilient means into a loaded state and lock the first engaging means with the second engaging means.

4. The manually detachable locking mechanism according to claim 2, wherein the first engaging means is movable from the third position to a fourth position along the direction of the axis relative to the second engaging means to thereby restore the resilient means to a partially relaxed state.

5. The manually detachable locking mechanism according to claim 4, wherein the fourth position is angularly spaced from the first position.

6. The manually detachable locking mechanism according to claim 1, wherein the first engaging means is movable from the first position to the second position towards the second engaging means.

7. The manually detachable locking mechanism according to claim 1, wherein the first engaging means is rotatably movable from the second position to the third position relative to the second engaging means.

8. The manually detachable locking mechanism according to claim 4, wherein the first engaging means is movable from the third position to the fourth position away from the second engaging means.

9. The manually detachable locking mechanism according to claim 4, wherein the first engaging means comprises a protruding portion engageable with a recess of the second engaging means to position the first engaging means at the second engaging means.

10. The manually detachable locking mechanism according to claim 9, wherein the protruding portion of the first engaging means is movable between the third position and the fourth position within the recess.

11. The manually detachable locking mechanism according to claim 3, wherein the guide portion of the second engaging means comprises a tapered portion with an inclined surface, the inclined surface is slidably engageable by the first engaging means to thereby guide the first engaging means in moving from the second position to the third position.

12. The manually detachable locking mechanism according to claim 11, wherein the tapered portion defines an inclined angle in a range of about 30 degree to about 50 degree between the inclined surface and a vertical plane parallel to the axis.

13. The manually detachable locking mechanism according to claim 11, wherein the second engaging means comprises at least one hook structure which integrally provides the tapered portion and the recess.

14. The manually detachable locking mechanism according to claim 13, wherein the second engaging means comprises a plurality of hook structures arranged to define a space for receiving at least partially the first engaging means.

15. The manually detachable locking mechanism according to claim 1, wherein at least one of the first engaging means and the second engaging means is formed of a sufficiently high strength material comprising one or more metals or metal alloys with hardness ranged from about HB60 to about HB100.

16. The manually detachable locking mechanism according to claim 1, wherein the first engaging means is associated with a blade unit of a propeller of the UAV, and that the second engaging means is associated with a rotor unit of a propeller of the UAV.

17. (canceled)

18. A propeller blade unit for an unmanned aerial vehicle (UAV), the propeller blade unit comprising:
a plurality of blades connected at a shaft; the shaft comprising at its lower portion an engaging means adapted to manually and releasably engage a rotor unit to thereby allow the plurality of blades be rotatable about an axis of the shaft;
wherein the engaging means comprises at least one protruding portion resiliently engageable with at least one corresponding receiving portion at the rotor unit to thereby lock the propeller blade unit at the rotor unit via a guided press and twist movement.

19. A rotor unit for an unmanned aerial vehicle (UAV), the rotor unit comprising:
an engaging means adapted to receive a shaft of a propeller blade unit; the engaging means comprising:
a resilient means arranged to allow a resilient engagement of the engaging means with the shaft;
a guide portion adapted to guide movement of the received shaft relative to the engaging means;
a recess adapted to lock position of the received shaft at the engaging means;
wherein the guide portion comprises a tapered portion slidably engageable by a protruding portion arranged at the shaft, such that the protruding portion is guided to move along a surface of the tapered portion and be subsequently received by the recess to thereby lock the propeller blade unit at the rotor unit.
